(19) United States
(12) Patent Application Publication
(10) Pub. No.: US 2023/0257490 A1
(43) Pub. Date: Aug. 17, 2023

(54) METHOD FOR PURIFYING A VINYLIDENE FLUORIDE POLYMER

(71) Applicant: ARKEMA FRANCE, Colombes (FR)

(72) Inventors: Brice ROUSSELLE, Pierre-Benite (FR); Béatrice ALLARD BRETON, Pierre-Benite (FR)

(21) Appl. No.: 18/006,289

(22) PCT Filed: Jul. 22, 2021
(86) PCT No.: PCT/EP2021/070612

§ 371 Date: Jan. 20, 2023

(30) Foreign Application Priority Data
Jul. 23, 2020 (FR) FR2007736

(51) Int. Cl. C08F 14/22; C08F 6/00

(52) U.S. Cl. CPC C08F 14/22; C08F 6/005

(57) ABSTRACT

The invention relates to a purification method for purifying a vinylidene fluoride polymer comprising at least one impurity, the method comprising the following steps: washing of the vinylidene fluoride polymer with a stream of supercritical fluid; and extraction of residual supercritical fluid from the vinylidene fluoride polymer.

The invention also relates to a vinylidene fluoride polymer, a fluid conveyance part comprising or consisting of said polymer; as well as the use of said fluid conveyance part.

### FIELD OF THE INVENTION

The present invention relates to a purification method for purifying a vinylidene fluoride polymer as well as a vinylidene fluoride polymer having a reduced content level of impurities.

### TECHNICAL BACKGROUND

In the field of electronics, electronic components such as of the semiconductor type are cleaned with ultra-high purity water. This ultra-high purity water is generally conveyed by means of a distribution system comprising tubes, valves and elbows made of vinylidene fluoride polymer.

For these applications, there are very important requirements with regard to the purity of the polymers used since the impurities present in the polymers can be released into the ultrapure water.

However, during the manufacture of the polymer, impurities such as ions, metals, or low molecular weight organic molecules are found to be trapped in the polymer.

Polymer purification methods for purifying fluoropolymers using a supercritical fluid are known.

For example, the document JP 2005-089524 describes a method for purifying a crystalline fluorinated resin in which the fluorinated resin is subjected to washing with supercritical carbon dioxide (CO₂), in particular in order to extract high molecular weight fluorinated impurities.

The document US 2019/0338114 describes a method for producing a copolymer of vinylidene fluoride and tetrafluoroethylene in which the prepared polymer, after having been amidated, is brought in contact with a supercritical fluid in order to extract from this polymer a component having a molecular mass comprised between 202 and 903.

However, the above methods do not enable sufficient removal of the impurities present in the vinylidene fluoride polymers and can lead to degradation of the mechanical properties of the polymer due to the presence of bubbles in the polymer, brought about by the treatment with supercritical CO₂.

There is therefore a real need for a purification method for purifying vinylidene fluoride polymers that provides the means to ensure more efficient removal of impurities, and in particular low molecular weight impurities, such as ions or volatile organic compounds (VOCs), and makes it possible to maintain (or even enhance) the good mechanical properties and the colour of the polymer.

### SUMMARY OF THE INVENTION

The invention relates in the first place to a purification method for purifying a vinylidene fluoride polymer comprising at least one impurity, the method comprising the following steps:

washing of the vinylidene fluoride polymer with a stream of supercritical fluid;

extraction of residual supercritical fluid from the vinylidene fluoride polymer.

According to certain embodiments, the vinylidene fluoride polymer is a polyvinylidene fluoride homopolymer or a copolymer comprising units derived from vinylidene fluoride and units derived from at least one second comonomer.

According to certain embodiments, the supercritical fluid comprises supercritical carbon dioxide.

According to certain embodiments, the washing of the vinylidene fluoride polymer with a stream of supercritical fluid is carried out in a reactor, preferably an autoclave.

According to certain embodiments, the washing of the vinylidene fluoride polymer with a stream of supercritical fluid is carried out at a pressure of 10 to 100 MPa, preferably 20 to 60 MPa; and/or at a temperature of 20 to 200° C., preferably 50 to 170° C.

According to certain embodiments, the quantity of supercritical fluid used for the washing of the vinylidene fluoride polymer amounts to from 1 to 30 kg per kg of vinylidene fluoride polymer and per hour, preferably from 3 to 15 kg per kg of vinylidene fluoride polymer and per hour.

According to certain embodiments, the supercritical fluid comprises a polar cosolvent, preferably selected from water and/or ethanol.

According to certain embodiments, the extraction of residual supercritical fluid is carried out by bringing the vinylidene fluoride polymer into contact, after washing, with a stream of inert gas, and/or by placing the vinylidene fluoride polymer after washing under vacuum.

According to certain embodiments, the inert gas is selected from the group constituted of air, dinitrogen, helium, argon, and mixtures thereof.

According to certain embodiments, the stream of inert gas is at a temperature of 20 to 140° C., preferably 70 to 120° C.; or the placing under vacuum is carried out at a temperature of 10 to 100° C., preferably 20 to 80° C.

According to certain embodiments, the washing of the vinylidene fluoride polymer with a stream of supercritical fluid takes place for a period of 1 to 12 hours, preferably 3 to 10 hours; and/or the extraction of residual supercritical fluid takes place for a period of 1 to 40 hours, preferably 5 to 30 hours.

According to certain embodiments, the at least one impurity is selected from the group constituted of anions, in particular fluoride anions and/or carbonate anions, organic compounds such as alcohols, carboxylic acids and/or esters, and mixtures thereof.

According to certain embodiments, the vinylidene fluoride polymer washed with the stream of supercritical fluid is in the form of granules, powder or a moulded part, preferably in the form of granules.

The invention also relates to a vinylidene fluoride polymer that has a content of organic compounds which is less than or equal to 1500 μg per m² of polymer and a content of fluoride anions which is less than or equal to 500 μg per m² of polymer.

According to certain embodiments, the above vinylidene fluoride polymer is obtained according to the method detailed here above.

According to certain embodiments, the polymer is in the form of granules.

The invention also relates to a fluid conveyance part comprising or consisting of the polymer as indicated here above or formed from the granules as indicated here above.

The invention also relates to the use of the above part for conveying ultra-high purity water for the cleaning of electronic components.

The present invention makes it possible to meet the need identified here above. It more particularly provides an improved purification method which makes it possible to obtain a vinylidene fluoride polymer that exhibits excellent purity by allowing for more efficient removal of the impurities contained in the polymer, and in particular of the low molecular weight impurities such as ions or VOCs or other low molecular weight organic compounds. In addition, the purification method according to the invention does not modify the chemical structure of the purified polymer and also does not result in degradation of either the mechanical properties or the colour thereof.

This is accomplished through the combination of a step of washing the vinylidene fluoride polymer with a supercritical fluid and a step of extraction of residual supercritical fluid from the polymer after the washing step. The treatment of the polymer with the supercritical fluid serves to ensure the removal of a portion of the impurities present in the polymer and the subsequent step of extraction of the supercritical fluid makes it possible to desorb and eliminate the supercritical fluid which has remained trapped within the polymer. In addition, the supercritical fluid desorbed during the extraction step carries away with it the organic impurities and ions, which makes it possible to further improve the purity of the polymer.

According to certain embodiments, in particular when the supercritical fluid is supercritical carbon dioxide, the invention consists of an environmentally friendly method of purification, which does not require the use of solvents that are harmful to the environment.

In addition, the present invention makes it possible to obtain a polymer which has a reduced content level of impurities, in particular of organic compounds as well as fluoride anions, without degrading the mechanical properties of the polymer and without affecting the colour of the polymer. This results in the obtaining of a good quality polymer, exhibiting good mechanical properties and having a high level of purity, thereby making it possible to limit the release of these impurities during the subsequent use of this product (for example during the use of a tube or pipe made from the polymer according to the invention for the conveyance of ultra-high purity water). The term “ultra-high purity water” is understood to refer to water having a maximum content of metallic and anionic impurities of 0.1 parts per billion (ppb) by weight, a total organic carbon (TOC) content of 10 ppb or less by weight, a non-volatile residues content of 0.1 parts per million (ppm) or less by weight, a resistivity of 18 MΩ·cm at 25° C. or more, and a content level of reactive silica impurities that is less than 1 ppb, in accordance with the standard SEMI F40.

### DETAILED DESCRIPTION

The invention shall be described in greater detail and in a non-limiting manner in the description that follows.

Method of Purification

The invention relates to a purification method for purifying a vinylidene fluoride polymer.

The term “vinylidene fluoride polymer” is understood to refer to any polymer that comprises units derived from vinylidene fluoride (VDF). The polymer may be a homopolymer or a copolymer, such as a bipolymer (that is to say, a polymer derived from the polymerisation of two monomers), a terpolymer (that is to say, a polymer derived from the polymerisation of three monomers), or a quaterpolymer (that is to say, a polymer derived from the polymerisation of four monomers). The term “copolymer” is understood to refer to a polymer derived from the copolymerisation of at least two monomers.

The vinylidene fluoride polymer may be a polyvinylidene fluoride homopolymer (PVDF).

The polymer may alternatively be a copolymer comprising units derived from vinylidene fluoride and units derived from at least one second comonomer. The second comonomer may be selected from the group constituted of hexafluoropropylene, fluoroethylene or vinyl fluoride, chlorofluoroethylenes (1-chloro-1-fluoroethylene and 1-chloro-2-fluoroethylene), trifluoroethylene, chlorodifluoroethylenes (in particular 1-chloro-2,2-difluoroethylene), 1-bromo-2,2-difluoroethylene, bromotrifluoroethylene, chlorotrifluoroethylene, tetrafluoroethylene, trifluoropropenes (in particular 3,3,3-trifluoropropene), tetrafluoropropenes (in particular 2,3,3,3-tetrafluoropropene or 1,3,3,3-tetrafluoropropene), chlorotrifluoropropenes (in particular 2-chloro-3,3,3-trifluoropropene), pentafluoropropenes (in particular 1,1,3, 3,3-pentafluoropropene or 1,2,3,3,3-pentafluoropropene), perfluoroalkyl vinyl ethers having the general formula Rf—O—CF—CF2, with Rf being an alkyl group, preferably a C1 to C4 alkyl group, and in particular PPVE (perfluoropropylvinylether) and PMVE (perfluoromethylvinylether) as well as combinations thereof.

The vinylidene fluoride copolymer may also, or alternatively, comprise units derived from non-fluorinated monomers such as ethylene, or acrylic monomers such as acrylic and methacrylic acids and polyacids.

The copolymer may consist of units derived from vinylidene fluoride and units derived from at least one second comonomer as mentioned here above.

The vinylidene fluoride polymer may be any mixture of two or more of the polymers mentioned here above.

The vinylidene fluoride polymer to be purified comprises at least one impurity. The at least one impurity may originate from the medium and from the conditions of polymerisation of the polymer during the manufacture thereof. In the embodiments, the one or more impurity(ies) may be organic compounds, such as alcohols, aldehydes, carboxylic acids and/or esters, and/or ions, in particular anions, preferably fluoride anions (F⁻), and/or carbonates. Preferably the organic compounds have a molar mass of less than 400 g/mol, more preferably less than 200 g/mol.

The quantity of organic compound impurities may be determined by performing a measurement of the “total organic carbon” (or TOC). The quantity of organic compounds as well as that of fluoride anions is thus determined using the following standards. The preparation of samples is carried out according to the standard SEMI F40-0699 (after about ten wash cycles with ultra pure water, 50 g of polymer is placed in a jar containing 250 mL of ultra pure water and then put in an oven at 85° C. for a period of 7 days). The organic compounds and fluoride anions present in the wash water are then analysed according to the standard test methods ASTM D4327 as for the measurement of fluoride anions, and ASTM D4779 and D5904 as for the measurement of organic compounds. A control sample that is free of any polymers is used for calibration. The values obtained are then converted into μg/m² equivalent according to the standard SEMI C69-1015. The measurement is preferably carried out on the polymer in the form of granules, but it may also be carried out on the polymer that is in the form of a powder. When the polymer is in the form of a part (in particular a moulded part), it is possible to cut one or more parts into fragments before performing the measurement.

In particular, the vinylidene fluoride polymer to be purified may include a content of organic compounds that is greater than or equal to 20,000 μg/m², preferably greater than or equal to 30,000 μg/m².

In particular, the vinylidene fluoride polymer to be purified may include a content of fluoride ions that is greater than or equal to 1500 μg/m², preferably greater than or equal to 5000 μg/m².

The vinylidene fluoride polymer is, according to a first step, brought into contact with a supercritical fluid in order to wash the vinylidene fluoride polymer with the supercritical fluid.

The vinylidene fluoride polymer is preferably in solid form during this first step. It may be in any suitable form, such as in the form of granules, or in the form of a powder, or in the form of a moulded part, for example in its final form, and in particular in the form of tubes or pipes. Preferably, the polymer is in the form of granules, which allows for easier implementation of the first step.

The polymer is subjected to a stream of supercritical fluid. In other words, the polymer is swept by the supercritical fluid. The stream of supercritical fluid enables the extraction of at least part of the impurities from the polymer. Therefore, after bringing the supercritical fluid into contact with the polymer, a stream of supercritical fluid loaded with impurities is recovered. Preferably, throughout this first step of bringing the polymer into contact with the supercritical fluid, the stream of supercritical fluid is supplied to the polymer in a continuous manner and the stream of supercritical fluid loaded with impurities, after having come into contact with the polymer, is withdrawn in a continuous manner.

In an advantageous manner, the step of bringing the polymer into contact with the supercritical fluid is carried out in a reactor. Preferably, the reactor is an autoclave. In a particularly preferred manner, the polymer, preferably in the form of granules, is placed in the reactor. The reactor preferably comprises an inlet for the stream of supercritical fluid, and an outlet for the stream of supercritical fluid loaded with impurities, with the stream of supercritical fluid circulating from the inlet to the outlet, and the inlet and the outlet for the supercritical fluid stream being separated by the vinylidene fluoride polymer bed.

The supercritical fluid comprises a supercritical fluid derived from an inert gas. In a particularly preferred manner, the supercritical fluid comprises supercritical carbon dioxide. Alternatively, or in addition, the supercritical fluid may comprise supercritical dinitrogen and/or supercritical argon.

In an advantageous manner, the supercritical fluid comprises at least 80% by weight of carbon dioxide, preferably at least 85% by weight, even more preferably at least 90% by weight, in particular at least 95% by weight, or at least 98% by weight of carbon dioxide. In some embodiments, the supercritical fluid consists of supercritical carbon dioxide.

The supercritical fluid may include at least one polar cosolvent. The polar cosolvent may be selected from the group constituted of water, organic solvents from the family of alcohols such as ethanol, propanol or others, and a mixture thereof. Preferably, the polar cosolvent is comprised in the supercritical fluid in an amount that is less than or equal to 20% by weight, preferably less than or equal to 15% by weight, for example in an amount ranging from 5 to 15% by weight, preferably from 8 to 12% by weight. The presence of a polar cosolvent in the supercritical fluid may make it possible to improve the purification by enhancing the spectrum of the impurities extracted by the supercritical fluid.

In this step, the quantity of supercritical fluid advantageously ranges from 1 to 30 kg, preferably from 3 to 15 kg, per kg of vinylidene fluoride polymer and per hour. In particular, the quantity of supercritical fluid may be from 1 to 3 kg, or 3 to 5 kg, or 5 to 8 kg, or 8 to 10 kg, or 10 to 12 kg, or 12 to 15, kg or 15 to 18 kg, or 18 to 20 kg, or 20 to 22 kg, or 22 to 25 kg, or 25 to 28 kg, or 28 to 30 kg.

Preferably, the step of bringing the vinylidene fluoride polymer into contact with the supercritical fluid is carried out at a pressure ranging from 10 to 100 MPa, preferably from 20 to 60 MPa, even more preferably from 20 to 50 MPa. In some embodiments, the pressure for the step of bringing the vinylidene fluoride polymer into contact with the supercritical fluid is: from 10 to 20 MPa, from 20 MPa to 30 MPa, from 30 MPa to 40 MPa, or from 40 to 50 MPa, or from 50 to 60 MPa, or from 60 MPa, or from 60 to 70 MPa, or from 70 to 80 MPa, or from 80 to 90 MPa, or from 90 to 100 MPa.

Preferably, the step of bringing the vinylidene fluoride polymer into contact with the supercritical fluid is carried out at a temperature ranging from 20 to 200° C., preferably from 50 to 170° C. In some embodiments, the temperature for the step of bringing the vinylidene fluoride polymer into contact with the supercritical fluid ranges from 20 to 30° C., or 30 to 40° C., or 40 to 50° C., or 50 to 60° C., or 60 to 70° C., or 70 to 80° C., or 80 to 90° C., or 90 to 100° C., or 100 to 110° C., or 110 to 120° C., or 120 to 130° C., or 130 to 140° C., or 140 to 150° C., or 150 to 160° C., or 160 to 170° C., or 170 to 180° C., or 180 to 190° C., or 190 to 200° C.

The step of bringing the vinylidene fluoride polymer into contact with the supercritical fluid stream preferably occurs over a duration ranging from 1 to 12 h, more preferably from 3 to 10 h; that is to say that the vinylidene fluoride polymer is swept with the stream of supercritical fluid over this period of time. According to some embodiments, the duration of this step is from 1 to 2 h, or from 2 to 3 h, or from 3 to 4 h, or from 4 to 5 h, or from 5 to 6 h, or from 6 to 7 h, or 7 to 8 h, or 8 to 9 h, or 9 to 10 h, or 10 to 11 h, or 11 to 12 h.

The stream of supercritical fluid loaded with impurities, that is collected after it has been brought into contact with the vinylidene fluoride polymer, may be subjected to a treatment in order to separate the impurities from the supercritical fluid, in a manner so as to obtain a purified supercritical fluid. Such a treatment may be purification on activated carbon or molecular sieve, bubbling in water followed by drying, decompression followed by gas/liquid separation or a combination of a plurality of these methods. The purified supercritical fluid may be recycled, at least in part, preferably in its entirety, as a stream of supercritical fluid to be brought into contact with the vinylidene fluoride polymer. The stream of supercritical fluid supplied to the vinylidene fluoride polymer may be supercritical fluid that has been purified (recycled) in its entirety, or in part (the purified supercritical fluid may for example be mixed with non-recycled supercritical fluid (also referred to as “new supercritical fluid” in this text)). The supply of the stream of supercritical fluid to the polymer can therefore be done in an open loop (that is to say that a stream of new supercritical fluid is supplied to the polymer) or in a closed loop (that is to say that the stream of supercritical fluid loaded with impurities is at least partly purified and at least partly recycled to be supplied again to the polymer).

Following this step of bringing the vinylidene fluoride polymer into contact with a stream of supercritical fluid, an impurity-depleted vinylidene fluoride polymer is recovered.

The vinylidene fluoride polymer that has been washed and thus depleted of impurities is subjected to a second step of “devolatilisation” or in other words a step of extraction of residual supercritical fluid from the vinylidene fluoride polymer after washing.

According to certain embodiments, this extraction step may be carried out by bringing the vinylidene fluoride polymer into contact after washing with a stream of inert gas. This gas may be selected from air, dinitrogen, helium, argon, as well as mixtures thereof. Preferably, air is at a temperature of from 70 to 120° C., more preferably from 80 to 100° C., for example at a temperature of from 70 to 80° C., or from 80 to 90° C., or from 90 to 100° C., or from 100 to 110° C., or from 110 to 120° C.

According to certain embodiments, the stream of inert gas may be at a temperature of 20 to 140° C., and preferably 70 to 120° C. This temperature may be for example from 20 to 30° C.; or from 30 to 40° C.; or from 40 to 50° C.; or from 50 to 60° C.; or from 60 to 70° C.; or from 70 to 80° C.; or from 80 to 90° C.; or from 90 to 100° C.; or from 100 to 110° C.; or from 110 to 120° C.; or from 120 to 130° C.; or from 130 to 140° C.

In the event of the extraction step being carried out by bringing the vinylidene fluoride polymer after washing into contact with a stream of inert gas, this step may be carried out at a pressure ranging from 1 to 2 bars absolute, and more preferably from 1 to 1.5 bars absolute.

Alternatively, this extraction step may be carried out by placing the vinylidene fluoride polymer under vacuum after washing. In this case, the placing under vacuum may be carried out at a temperature of 10 to 100° C., preferably 20 to 80° C. This placing under vacuum may for example be carried out at ambient temperature.

In the event of the extraction step being carried out by placing the vinylidene fluoride polymer under vacuum after washing, this step may be carried out at a pressure ranging from −0.9 to −0.01 relative bar.

The step of extraction of residual supercritical fluid from the washed vinylidene fluoride polymer may take place over a period of 1 to 40 h, preferably 5 to 30 h.

According to certain embodiments, this step may be carried out in the same reactor (for example the same autoclave) used for the first step.

According to other embodiments, this step may be carried out in a reactor that is different from the one used for the first step.

At the end of this step, a vinylidene fluoride polymer having an even further reduced content of impurities is recovered. As detailed previously, this impurity may be selected from the group constituted of anions, in particular fluoride anions and/or carbonate anions, organic compounds such as alcohols, carboxylic acids and/or esters, and mixtures thereof.

Thus, the method according to the invention (more particularly the combination of a step of washing the vinylidene fluoride polymer with a stream of supercritical fluid and a step of extraction of residual supercritical fluid from the washed vinylidene fluoride polymer) makes it possible to reduce the content of impurities in the purified polymer. More particularly, the method according to the invention makes it possible to reduce the content of organic compounds by a value greater than or equal to 90%, and preferably greater than or equal to 95%. For example, this content may be reduced by 90 to 92%; or by 92 to 94%; or by 94 to 96%; or by 96 to 98%; or by more than 98%.

In addition, the method according to the invention makes it possible to reduce the content of fluoride anions by 50 to 95% (relative to the polymer prior to purification), and preferably by 65 to 90%. For example, this content may be from 50 to 55%; or from 55 to 60%; or from 60 to 65%; or from 65 to 70%; or from 70 to 75%; or from 75 to 80%; or from 80 to 85%; or from 85 to 90%; or from 90 to 95%.

The content levels of organic compounds as well as of fluoride anions are assessed as detailed here above.

Purified Vinylidene Fluoride Polymer

As described previously in the description, the polymer obtained by the method detailed here above has a reduced content of impurities (as described here above) relative to the polymer prior to purification.

More particularly, the vinylidene fluoride polymer according to the invention has a content of organic compound of less than or equal to 1500 μg per m² of polymer. For example, this content may be less than or equal to 1500 μg per m² of polymer, or less than or equal to 1400 μg per m² of polymer, or less than or equal to 1300 μg per m² of polymer, less than or equal to 1200 μg per m² of polymer, or less than or equal to 1100 μg per m² of polymer, or less than or equal to 1000 μg per m² of polymer, or less than or equal to 900 μg per m² of polymer, or less or equal at 800 μg per m² of polymer, or less than or equal to 700 μg per m² of polymer, or less than or equal to 600 μg per m² of polymer, or less than or equal to 500 μg per m² of polymer.

In certain embodiments, the polymer has an organic compound content ranging from 10 to 1500 μg per m² of polymer, in particular from 100 to 1200 μg per m² of polymer, for example from 200 to 1000 μg per m² of polymer.

In addition, the vinylidene fluoride polymer according to the invention has a content of fluoride anions of less than or equal to 500 μg per m² of polymer. For example, this content may be less than or equal to 500 μg per m² of polymer, or less than or equal to 450 μg per m² of polymer, or less than or equal to 400 μg per m² of polymer, less than or equal to 350 μg per m² of polymer, or less than or equal to 300 μg per m² of polymer, or less than or equal to 250 μg per m² of polymer, or less than or equal to 200 μg per m² of polymer, or less than or equal to 150 μg per m² of polymer, or less than or equal to 100 μg per m² of polymer.

In certain embodiments, the polymer has a content of fluoride anions ranging from 10 to 500 μg per m² of polymer, in particular from 20 to 200 μg per m² of polymer, for example from 30 to 100 μg per m² of polymer.

The content levels of organic compounds and fluoride anions are measured using the method as described here above.

Thus, the polymer according to the invention has a reduced content of impurities (without degradation of the polymer's mechanical properties), which makes it possible to subsequently limit the release of impurities, that is to say at the time of use of the product. The mechanical properties include, for example, temperature of thermal degradation, melting temperature, crystallisation temperature, weight loss at high temperature (for example 270° C.), crystallinity index, tensile strength, elongation at break and elongation at yield.

According to certain embodiments, the colour of the purified polymer is not affected by the purification method according to the invention—which is reflected in the “yellow index” of the purified polymer being lower than the yellow index of the polymer to be purified—or is even enhanced. According to the preferred embodiments, the yellow index of the purified polymer is lower by at least 1 than the yellow index of the polymer to be purified. This index is measured using the method specified in NF EN ISO/CIE 11664-4 of July 2019.

The polymer according to the invention may be used in particular for the manufacture of parts, in particular tubes, valves or elbows, for conveying very high purity water for cleaning electronic components (such as semiconductor compounds).

Alternatively, the polymer may be in the form of such parts prior to the implementation of the method of the invention that makes it possible to purify the latter.

### EXAMPLES

The following examples illustrate the invention without any limitation thereof.

### Example 1

First of all, a comparison is performed between the method according to the invention and a method which does not have a step of extraction of residual supercritical fluid.

In order to do this, in a reactor of such type as an autoclave, a vinylidene fluoride homopolymer in the form of granules was washed with a stream of supercritical carbon dioxide at a pressure of 500 bars, at a temperature of 140° C., and with a ratio of quantity of CO₂ to quantity of polymer/hour equal to 15. The polymer to be purified has a content of organic compounds equal to 22,536 μg/m². After this step, the content of organic compounds in the polymer after being washed was measured to be 4341 μg/m² as described in the description. It is found that the content of organic compounds has been reduced by 81%. Thereafter, the polymer obtained after washing underwent a step of extraction of residual carbon dioxide by blowing filtered air at 95° C. for a period of 20 hours. After this step, the content of organic compounds in the polymer after washing is measured to be 980 μg/m² as described in the description. It is found that the content of organic compounds has been reduced by 96%. As a consequence thereof, the method according to the invention and more particularly the combination of a step of washing the vinylidene fluoride polymer with carbon dioxide and a step of extraction of residual carbon dioxide from the polymer after the washing step makes it possible to considerably reduce the content of organic compounds as compared to a method that does not have an extraction step.

### Example 2

In this example, three polymer samples (A, B, C) were purified in accordance with the method according to the invention. These three samples come from different production batches resulting from the same recipe and having varying levels of organic compounds. The content of organic compounds and fluoride anions was measured for each sample.

In order to do this, in an autoclave reactor a vinylidene fluoride homopolymer in the form of granules was washed with a stream of supercritical carbon dioxide at a pressure of 300 bars, at a temperature of 130° C., and with a ratio of quantity of CO₂ to quantity of polymer/hour equal to 15.

To extract the residual CO₂, the granules were then swept for 21 hours by a stream of hot air (90° C.) at atmospheric pressure.

The content levels of organic compounds and fluoride anions were measured as detailed in the description and the results are illustrated in the table here below.

TABLE 1

| | | A | B | C |
|---|---|---|---|---|
| Values prior | Organic compound content | 22536 | 13361 | 16813 |
| to treatment | (per μg/m² of polymer) | | | |
| | Fluoride anion content | 3876 | 3952 | 4131 |
| | (per μg/m² of polymer) | | | |
| Values post | Organic compound content | 1374 | 1001 | 813 |
| treatment | (per μg/m² of polymer) | | | |
| | Fluoride anion content | 374 | 362 | 438 |
| | (per μg/m² of polymer) | | | |

It is thus noted that the three polymer samples after treatment have an organic compound content of less than 1500 μg per m² of polymer and a fluoride anion content of less than 500 μg per m² of polymer, which thereby supports the conclusion that the polymers purified in accordance with the method according to the invention have a high purity level and may be used without risk of subsequent release of the impurities.

### Example 3

In this example, the yellow index of these three samples (A, B, C) was measured prior to and post purification in accordance with the method according to the invention. The method used to measure the yellow index is that of NF EN ISO/CIE 11664-4 of July 2019. The corresponding results are illustrated in the table below.

TABLE 2

| Sample | A | B | C |
|---|---|---|---|
| Yellow index prior | 7.3 | 5.4 | 2.8 |
| to purification | | | |
| Yellow index post | 6 | 3.7 | 1.7 |
| purification | | | |

It is observed that the purification of the polymer according to the invention does not adversely affect the colour of the polymer obtained. More particularly, it is observed that post purification, the purified polymer exhibits a reduced yellow index as compared to the polymer prior to purification, which thereby supports the conclusion that the colour of the purified polymer is enhanced.

### Example 4

In this example, the mechanical properties of a polymer sample that is in the form of granules were compared prior to and post purification (samples D—prior to purification and E—post purification) in accordance with the method of the present invention as described in Example 2.

The following mechanical properties were studied:

Thermal stability measured by TGA (thermogravimetric analysis), in accordance with the standard ISO 11358-1:

TABLE 3

| | Temperature at the | Loss over the course of a |
|---|---|---|
| Sample | start of degradation | 1 hour isotherm at 270° C. |
| D | 433.2 | 0.1 |
| E | 431.7 | 0.1 |

An isothermal crystallinity measured by means of DSC (differential scanning calorimetry) accordance with the standard ISO 11357-3:

TABLE 4

| | 1^{st} Heating | | | Cooling | | 2^{nd} Heating | | |
|---|---|---|---|---|---|---|---|---|
| | T_{g} | T_{f} | Enthalpy | T_{c} | Enthalpy | T_{g} | Tf | Enthalpy |
| Sample | (° C.) | (° C.) | (J/g) | (° C.) | (J/g) | (° C.) | (° C.) | (J/g) |
| D | −41.3 | 168.5 | 55 | 138.0 | 59 | −41.7 | 166.4 | 61 |
| E | −41.4 | 170.9 | 68 | 138.2 | 58 | −43.5 | 165.4 | 60 |

Crystallisation kinetics measured by means of DSC (differential scanning calorimetry) accordance with the standard ISO 11357-3:

TABLE 5

Crystallisation Half-time at 152° C.

| Sample | After 20 min at 220° C. | After 20 min at 270° C. |
|---|---|---|
| D | 11.7 | 22.2 |
| E | 11.6 | 22.0 |

Based on the above tables, it may be noted that the mechanical properties of the polymer are not negatively impacted by the purification method according to the invention. Thus, the method according to the invention makes it possible to obtain a purified polymer while also maintaining good mechanical properties of the polymer.

1. A purification method for purifying a vinylidene fluoride polymer comprising at least one impurity, the method comprising:
washing of the vinylidene fluoride polymer with a stream of supercritical fluid; and
extracting of residual supercritical fluid from the vinylidene fluoride polymer, said extraction of residual supercritical fluid being carried out by bringing the vinylidene fluoride polymer into contact, after washing, with a stream of inert gas and/or by placing the vinylidene fluoride polymer after washing under vacuum.

2. The purification method of claim 1, wherein the vinylidene fluoride polymer is a polyvinylidene fluoride homopolymer or a copolymer comprising units derived from vinylidene fluoride and units derived from at least one second comonomer.

3. The purification method of claim 1, wherein the supercritical fluid comprises supercritical carbon dioxide.

4. The purification method of claim 1, wherein the washing of the vinylidene fluoride polymer with a stream of supercritical fluid is carried out in a reactor.

5. The purification method of claim 1, wherein the washing of the vinylidene fluoride polymer with a stream of supercritical fluid is carried out at a pressure of 10 to 100 MPa and/or at a temperature of 20 to 200° C.

6. The purification method of claim 1, wherein a quantity of supercritical fluid used for the washing of the vinylidene fluoride polymer amounts to from 1 to 30 kg per kg of vinylidene fluoride polymer and per hour.

7. The purification method of claim 1, wherein the supercritical fluid comprises a polar cosolvent.

8. The purification method of claim 1, wherein the inert gas is selected from air, dinitrogen, helium, argon, and mixtures thereof.

9. The purification method of claim 1, wherein the stream of inert gas is at a temperature of 20 to 140° C.; or the placing under vacuum is carried out at a temperature of 10 to 100° C.

10. The purification method of claim 1, wherein the washing of the vinylidene fluoride polymer with a stream of supercritical fluid takes place for a period of 1 to 12 hours; and/or the extraction of residual supercritical fluid takes place for a period of 1 to 40 hours.

11. The purification method of claim 1, wherein the at least one impurity is selected from the group constituted of anions, organic compounds, and mixtures thereof.

12. The purification method of claim 1, wherein the vinylidene fluoride polymer washed with the stream of supercritical fluid is in a form of granules, powder or a moulded part.

13. A vinylidene fluoride polymer that has a content of organic compounds which is less than or equal to 1500 μg per m² of polymer and a content of fluoride anions which is less than or equal to 500 μg per m² of polymer.

14. (canceled)

15. The vinylidene fluoride polymer of claim 13, wherein the vinylidene fluoride polymer is in a form of granules.

16. A fluid conveyance part comprising:
a vinylidene polymer that has a content of organic compounds which is less than or equal to 1500 μg per m² of polymer and a content of fluoride anions which is less than or equal to 500 μg per m² of polymer.

17. A method for conveying ultra-high purity water for cleaning of electronic components comprising using the part of claim 16 for conveying the ultra-high purity water.

18. The purification method of claim 4, wherein the reactor is an autoclave.

19. The purification method of claim 7, wherein the polar cosolvent is selected from the group consisting of water, ethanol, and mixtures thereof.

20. The purification method of claim 11, wherein the anions are selected from the group consisting of fluoride anions, carbonate anions and mixtures thereof.

21. A vinylidene fluoride polymer obtained according to the purification method of claim 1, wherein the vinylidene polymer comprises a content of organic compounds which is less than or equal to 1500 μg per m² of polymer and a content of fluoride anions which is less than or equal to 500 μg per m² of polymer.
